(19) United States
(12) Patent Application Publication
(10) Pub. No.: US 2006/0085747 A1
(43) Pub. Date: Apr. 20, 2006

(54) Method and apparatus for presenting technical architectural patterns and solutions

(76) Inventor: Robert Morgan, Glendale, AZ (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/959,006

(22) Filed: Oct. 5, 2004

(51) Int. Cl. G06F 9/00

(52) U.S. Cl. 715/700

(57) ABSTRACT

A multi-layer visual representation of technical architecture and various other architecture disciplines provides views that are linked horizontally and vertically, allowing for ease of navigation from conception to development to physical representations of architecture for a technology solution. The vertical layers represent the layers of abstraction of the architecture from business concept to physical implementation. Each layer in the stack represents a plane that can be traversed horizontally for a complete perspective of the layer.

### FIELD OF THE INVENTION

This invention generally relates to data processing for hardware/software architecture development, installation, and management; and in particular it relates to visual modeling.

### BACKGROUND OF THE INVENTION

Representing the various facets of technical architecture, business architecture, and operations and engineering solution diagrams has been a difficult problem for a long time. Particularly so since the mid-1990's when technical solutions began to get more complicated, for example, with the rapidly expanding array of new technology products available to businesses for interacting with vendors and consumers on the World Wide Web. The problem was, and remains, the manner in which various technical domains (e.g. hardware and software components), technical solutions, representations of subject matter experts (SME's) and the like are to be inter-related in such a way so as to reduce and eventually eliminate inconsistencies between the various project perspectives and disciplines involved.

Prior attempts have been and continue to be mostly domain-focused and do not try and span all architecture domains and disciplines into a single, navigable visual presentation. Most drawings of technical architecture now used are flat, static diagrams of partial solutions in separate files. The typical representation of technical drawings, as has been done in the past, does not provide a connected navigation scheme that can be traversed by all groups involved in implementing a solution. Nor do these representations provide the different perspectives and the context sensitive information related to each view and layer of a development project being implemented. All diagrams typically use different notations and offer no simple way to navigate between them.

Some industry work around Enterprise Architecture Frameworks has been done in this field over the years, such as the Zachman framework where there are different perspectives or domain representations. Most of these models are paper based, mainly textual in nature, and therefore, not easy to navigate.

Accordingly, there is a need for a method and apparatus for visually representing technical architecture plans that addresses certain problems of existing technologies.

### SUMMARY OF THE INVENTION

It is an object of the present disclosure, therefore, to introduce various embodiments of a method and apparatus for presenting a technical architectural patterns and solutions (TAPS) framework to a user on a computing device, in which the user may create and store a plurality of pages that visually represent separate levels of implementation of a development project. The user may assign component symbols to one or more types of components to be implemented in the development project. The component symbols may include metadata and network pointers to additional detailed information of the component represented by the respective symbol. The user may also assign a color to one or more groups of personnel involved in the development project. The colors may be applied to various of the symbols placed within the pages of the development plan, based on the group of personnel responsible for implementation of the subject component. The user may also associate additional individual users with appropriate groups of personnel. As a result, the software introduced herein may more prominently display those symbols having a color corresponding to a particular group when a user of that group is viewing the pages of the development project. Symbols having colors relating to other groups may be less prominently displayed, or may not be viewable at all, to users who are not members of the group assigned to implementing those components.

A user creating a representation of a layout plan may also include component connection symbols showing the interconnections of components in the development plan. The user may also define certain symbols that are viewable by all groups, such as file folders of general or detailed information. Finally, the user may utilize various predefined on-page connectors, off-page connectors and component symbols, each having a shape that suggest a direction within the pages of the development plan in which to navigate to obtain more information related to the caption of the connector.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a schematic representation of various successive levels of a technical architecture plan according to certain aspects of the present disclosure;

FIG. 2 is a flowchart depicting an exemplary method for generating a technical architecture plan according to the present disclosure;

FIG. 3 is a display of a highest level of an exemplary technical architecture plan;

FIG. 4 is a display of a second level of an exemplary technical architecture plan;

FIG. 5 is a display of a third level of an exemplary technical architecture plan;

FIG. 6 is a display of a fourth level of an exemplary technical architecture plan; and

FIG. 7 is a display of an exemplary symbol legend for a technical architecture plan.

### DETAILED DESCRIPTION OF THE SPECIFIC EMBODIMENTS

The conventional wisdom of previous attempts to organize development projects involving multiple disciplines was to have many complex diagrams that attempt to illustrate the many technologies or perspectives on a single page, or to provide several unrelated diagrams produced by many different SMEs with non-standardized notations and no linking of project components. The prospect of presenting an entire technical plan with continuity and in a manner that is meaningful and understandable by all the groups of personnel involved has been viewed with skepticism.

The TAPS solution, introduced herein in response to that problem, is unconventional in that in breaks up the various aspects of a development project into small modular components that can be reused and linked to from various other components of the technical architecture plan. The TAPS framework provides multiple views to different technical disciplines including, for example, hardware components, software development, engineering, and operations/information technology (IT) support. Each view can be linked to, or traced back to, another layer or page level in the technical architecture plan. This allows the individuals with different perspectives to see how their domain fits into the overall context of the technical solution, with quick reference to organizational and industry standards provided. The underlying connections between all the layers and connections and objects on the page are done using standard Web technologies of hyperlinks so that the drawings can span computer systems also. This allows for collaborative construction of the pages/layers and the ability to connect to them using hyperlinks. TAPS is dynamic, easy to navigate and extend, and provides contextual technical information relevant to each layer and view of a technical architecture plan.

TAPS brings all the pieces of a development project or enterprise technical architecture together in a straightforward manner that provides the ability for various disciplines to combine their information and requirements into a meaningful visual representation. It allows users to navigate through the resulting technical architecture plans within the specific context of their respective responsibilities and areas of expertise. A technical plan implemented by TAPS software is extensible and can be worked on by multiple personnel who are responsible for portions of the overall solution. The solution clearly defines the boundaries of architecture and implementation, using off-page connections and color assignments for connectors and symbols, and allows multiple groups/companies/partners to work collaboratively within a framework of established interfaces.

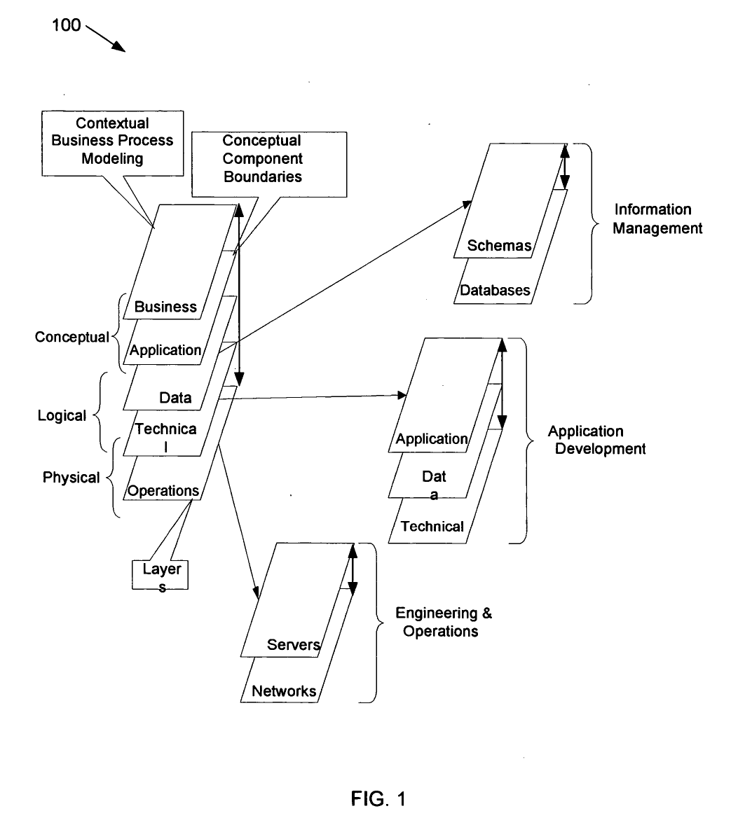

Referring now to FIGS. 1-7, wherein similar components of the present disclosure are referenced in like manner, various embodiments of a method and apparatus for presenting technical architectural patterns and solutions will now be disclosed. The TAPS framework is described below with respect to the implementation of a specific type of development project, namely, a corporation's implementation of new hardware/software/network infrastructure for a business-to-consumer (B2C) Internet application. However, it is readily contemplated that the solution introduced herein may be used for any of a variety of projects, or as a general organization tool for any number of disciplines or types of users. Accordingly, the descriptions of specific implementations described in the following should be viewed as illustrative only, and should not be construed to limit the applicability of the process presented.

Turning now to FIG. 1, there is depicted one example of the conceptual layout 100 of a particular technical architecture plan to be developed within the TAPS framework. A technical architecture plan generated within the framework may be thought of as having a number of layers of successively increasing detail of various aspects of implementation of a development project. In the example of FIG. 1, the topmost, more conceptual layers include the general layout of the development project and general descriptions of the business processes or models involved in the solution.

As a user navigates to lower layers of the plan, by selecting various page connector or component symbols on a layer of the plan, the various logical and physical components that are to be implemented for the solution are represented in successively greater detail, along with their interconnections to other components within the technical architecture plan Each layer may contain components relating to any number of disciplines involved in the project, and certain layers may be dedicated to certain disciplines (i.e., “Information Management,” “Application Development,” “Engineering and Operations,” and the like). Layers may be laid out and assigned in any manner desired by a user or group of collaborating users.

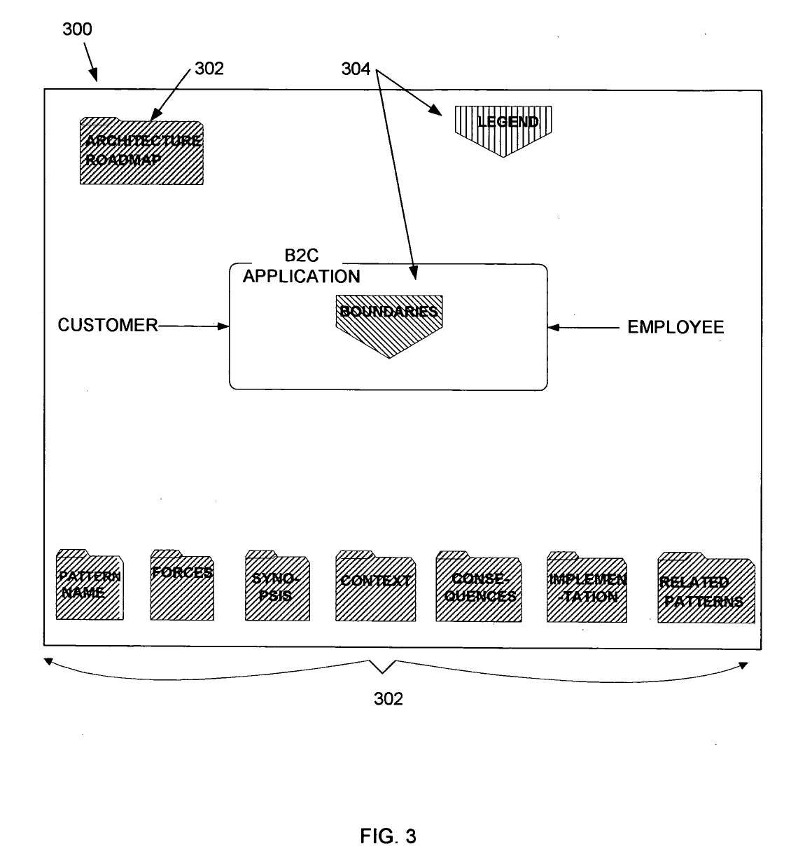

The actual visual presentation of a technical architecture plan created within the framework differs from the conceptual layout 100 of FIG. 1, in that the plan will appear as a single, continuously-navigable, visual presentation with standardized navigation controls that are presented in successive views. Examples of various views that may be created within the TAPS framework are displayed in FIGS. 3-7, and will be described in more detail later below.

The ease of use of navigability within the TAPS framework is accomplished by introducing standardized page connector and component symbols having a suggestive caption and any of a variety of shapes, the orientation of which suggests to a user the direction within the plan (i.e., up, down, left or right) in which to navigate to get more specific information related to the caption. The various symbols themselves are selectable by a user, in order to navigate them directly to such further information, which may appear in separate plan views.

The page connector symbols, component symbols, as well as the various component connector symbols, general symbols and file folder symbols as described herein, may be generated within a computer aided design program, such as MICROSOFT VISIO PROFESSIONAL Page: 7

or any of a number of other available computer aided design (CAD) drawing tools, and stored in a symbol library or other centralized location. These symbols may each be configured to include metadata, network pointers (i.e. hyperlinks) to related textual or data files, and a descriptive text caption. The network pointers may be in the form of a Uniform Resource Identifier (URI), which is a general form of a Uniform Resource Locator (URL), and identifies a file having further graphic and/or textual information.

Each symbol used within the TAPS framework may also be configured to present “pop-up” information in response to a mouse-over or similar event. A separate pop-up window is displayed in proximity to the appropriate symbol, and may present further information, such as technical specifications, textual descriptions of the component, hardware/software compatibility, or the like.

The shape of the various component symbols used in the technical architecture plan may be assigned by a user based on the component it represents, as is done in a wide variety of existing CAD programs. However, the TAPS framework differs in that the component symbols will typically comprise basic shapes only, such as substantially square or rectangular shapes, and may include textual captions, as well as metadata, pop-up information and network pointers, as previously described. In addition, certain of the component symbols may include an indicator of a direction in the technical architecture plan in which the user may navigate to more specific information about the component. For example, a component symbol may include a convex or concave arrowhead indicative of the direction in the technical architecture plan containing more information (i.e., up or down for different layers of the plan, and left or right for further information on the same level). The component symbols may be selected by a user, for example, by selecting the component with a mouse or similar user input device, to automatically navigate to the location in the technical architecture plan having such further information.

The TAPS framework may also include user-selectable on-page or off-page connector symbols for navigating to other views of the technical architecture plan. The on-page connector symbols may be simple shapes that include a convex or concave arrowhead, which points left or right only in the various pages of the technical architecture plan. The on-page connector symbols may include captions to indicate the further information available in that direction.

The off-page connectors (OffCons) may include a caption indicative of the level or page to which a user will be navigated by selecting the OffCon. Offcons have exactly two general orientations: up or down. Those OffCons pointing up and down may be referred to herein as OffCon-Up and OffCon-Down, respectively. When selected, the OffCon-Up symbols will navigate a user to a higher level of the technical architecture plan. Similarly, the OffCon-Down symbols, when selected, will navigate a user to a lower (less abstract, more detailed) level in the technical architecture plan.

In addition to the component symbols and on-page and off-page connectors above, the TAPS framework may include three additional categories of symbols, each of which may contain captions, metadata, network pointers and pop-up information as described above. Component connector symbols, such as dynamic line connector, may be placed within the framework to show the interconnection of components within the technical architecture plan. File folder symbols may be placed within the technical architecture plan to navigate users to relevant, mainly textual documentation that pertains to the level of the technical architecture plan being viewed. Finally, general component symbols may be included, which are not assigned any one group-based attribute, and which may be displayed to all users. Each of these symbols may be selectable to a user and may, via a mouse-over or similar effect, Page: 9

provide a popup window of related information, such as a policy, further documentation or organizational and industrial standards that apply to the given connectors or symbols. Selecting the symbols or connectors, on the other hand, will result in a separate window containing the related information.

The various symbols described above may be created by a user and placed on various pages, such as internet web pages in hyper-text transfer protocol (HTTP) format. Accordingly, the TAPS framework may be viewed by using an Internet browser program, such as MICROSOFT INTERNET EXPLORER, or within any other desired desktop application. Each page may represent a full or partial layer of the technical architecture plan. Instead of navigating through the layers in page order, as done consistently in previous technologies, the technical architecture plan within the TAPS framework may be navigated by selecting any symbols of interest that appear therein.

A further feature of the TAPS framework involves assigning colors or attributes to the various symbols described above. In particular, creators of a technical architecture plan may assign specific colors to specific groups of personnel involved in implementing the project. Continuing with the example described above, such groups may include: vendors providing various hardware components for the B2C project being implemented, software technicians developing the software being implemented in the B2C solution, IT personnel responsible for maintaining operability and network security, network administrators and any other of a variety personnel from various disciplines. Within the TAPS framework, network administrators may be assigned the color red, IT personnel may be assigned the color blue, and so forth. The colors are applied to the symbols within the technical architecture plan for which the group associated with that color is responsible. In this manner, a user belonging to one of the groups of personnel can quickly recognize the relevant aspects of the technical architecture plan simply by identifying those symbols having the color assigned to the user's group. This makes relevant symbols more prominent to users belonging to any of the groups. Other colors may be assigned to those symbols that are not group-specific, or assigned to more than one group.

The TAPS framework enables other ways to make relevant symbols more prominent to users viewing a technical architecture plan. In various embodiments, the file in which a technical architecture plan is stored may be protected, and may require a user to enter a valid login identifier or login identifier/password combination to access the plan. In order to accomplish this, the creators of the plan may maintain a secured database of users authorized access to the plan, and further store the group to which each user belongs in the records of that database. The login identifier entered by a subsequent user may then be verified against those database records.

The login functionality is then harnessed by the TAPS framework to provide other ways in which relevant symbols may be more prominently displayed to a user. For example, after identifying a user and the group to which the user belongs, the display of the technical architecture plan may show only those components having the color assigned to that user's group. The remaining components may be grayed out, or may be removed completely from the display. This may be done by providing appropriate programming instructions within the technical architecture plan to present only symbols of a certain color or colors, based on the group to which the user viewing the plan belongs. In further embodiments, the user may selectively turn on and off the display of symbols of various colors by selecting menu commands provided to achieve such function.

In still further embodiments, an attribute other than or in addition to color may be assigned to each group. For example, each group may be assigned a symbol shape, a text attribute (i.e. underline, bold, caps, font type, or font color), a border pattern, or any of a variety of other shape or text attributes. In addition, symbols relevant to a user may be highlighted or may flash, as desired.

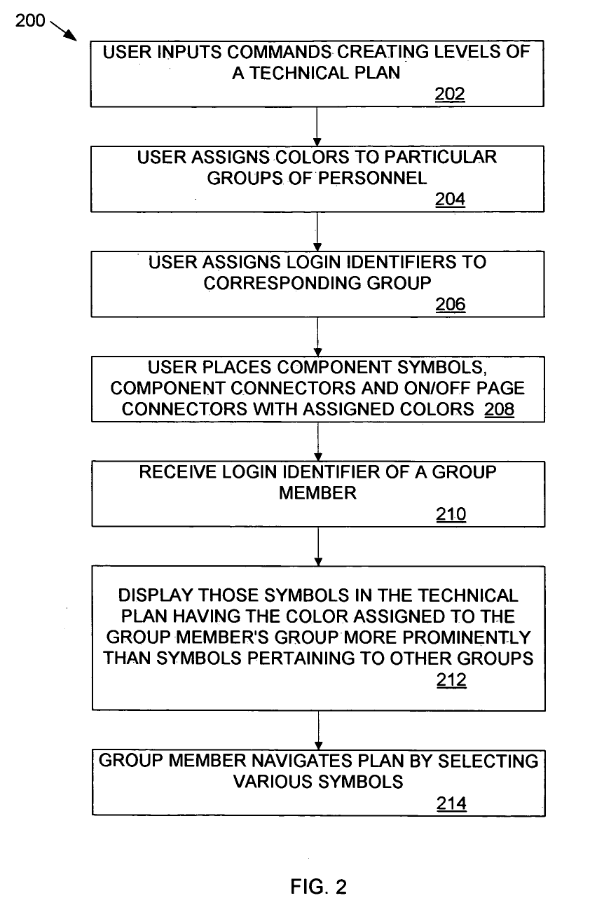

Turning now to FIG. 2, therein is depicted an exemplary process 200 by which a user or group of collaborating users may create and present a technical architecture plan using the TAPS framework. The user creates a number of pages representing the various levels or views of a technical architecture plan (step 202). The user also assigns a specific color or attribute to various groups involved in implementing the technical architecture plan (step 204). The user then associates various authorized login identifiers and the group to which each login identifier belongs (step 206). The user places component symbols, component connector symbols, on-page connectors, off-page connectors, file folders with assignment of appropriate colors (or other attributes), after which the plan may be accessed by other users (step 208).

After creation of a version of the plan, a subsequent user accesses the plan by entering a login identifier (step 210). The TAPS framework then presents to that user those symbols in the technical architecture plan having the color or attribute assigned to that user's group (step 212). The symbols relevant to that user may be more prominently than other symbols pertaining to other groups, in any of the manners described above. The subsequent user may then navigate through the technical architecture plan by selecting the symbols displayed (step 214). The various steps of the process 200 may be performed or repeated by any number of users in any order as the technical architecture plan is continually accessed or expanded.

FIGS. 3-7 depict various views of a technical architecture plan created with the TAPS framework. The batching on the various symbols presented therein is meant to represent the coloring that may be assigned thereto, with different hatch patterns representing different colors.

Turning now to FIG. 3, therein is depicted a display 300 of a top layer of an exemplary technical architecture plan created within the TAPS framework. In this example, a B2C application is being developed for interfacing between an organization's computer data systems and its customers. Selection of any of the file folder symbols 302 will navigate a user to textual descriptions of the project aspect suggested by the symbol's caption (“Architecture Roadmap,” “Pattern Name,” “Forces,” “Synopsis,” etc.). Selection of the OffCon-Down symbols 304 will navigate a user to a next lower level of the technical architecture plan having information related to the caption of the OffCon-Down symbols 304.

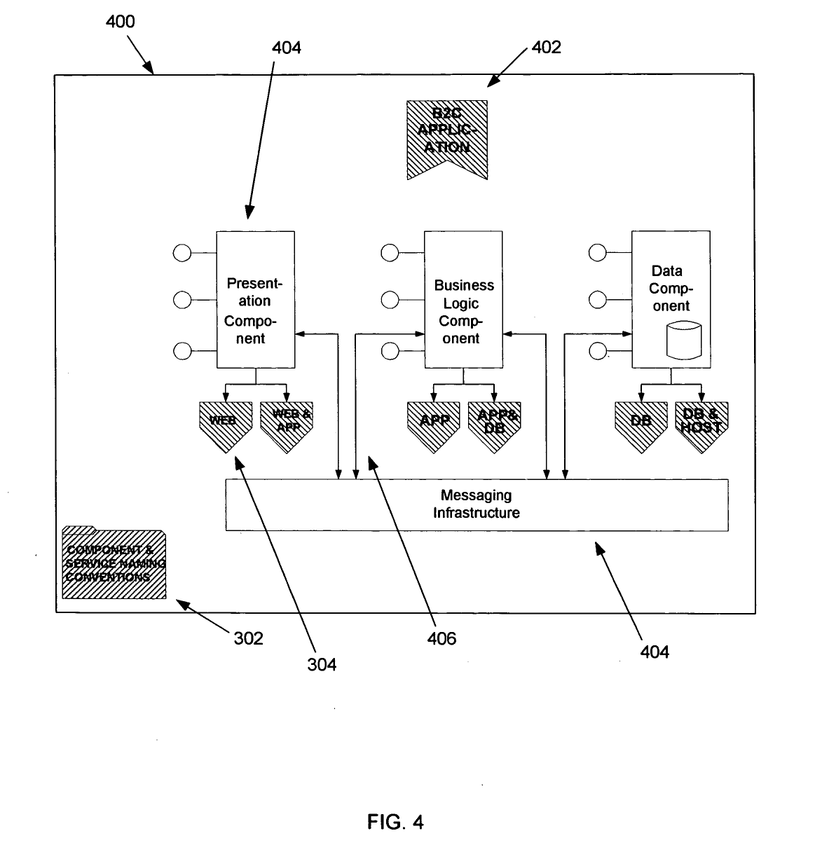

Turning now to FIG. 4, therein is depicted a display 400 of a lower layer of an exemplary technical architecture plan created within the TAPS framework. Selection of the OffCon-Up symbol 402 (shown with a concave arrowhead shape indicating an up direction) will navigate a user to a higher level within the technical architecture plan corresponding to the caption. Non-group specific symbols 404 and component connector symbols 406 are also displayed.

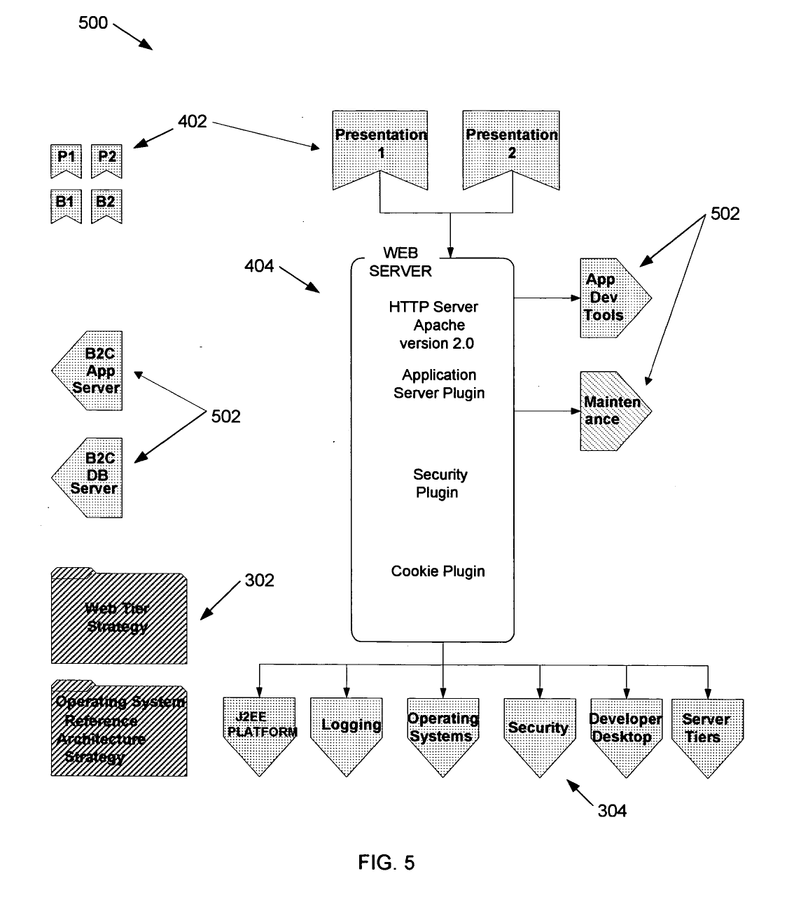

In FIG. 5, there is depicted a display 500 of a still lower level of the exemplary technical architecture plan, wherein on-page connector symbols 502 having convex arrowheads indicating a left or a right direction are shown.

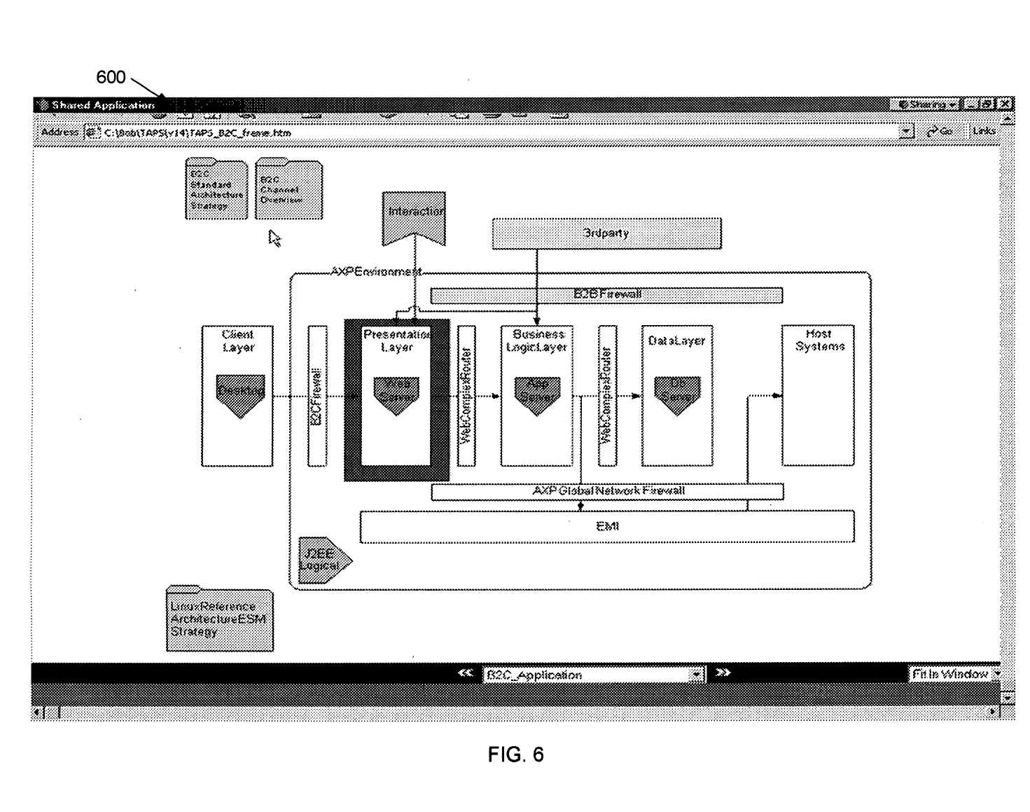

Referring now to FIG. 6, therein is a display 600 of a further subsequent level of the exemplary technical architecture plan, in which various symbols have been highlighted in order to make them more prominent to a user.

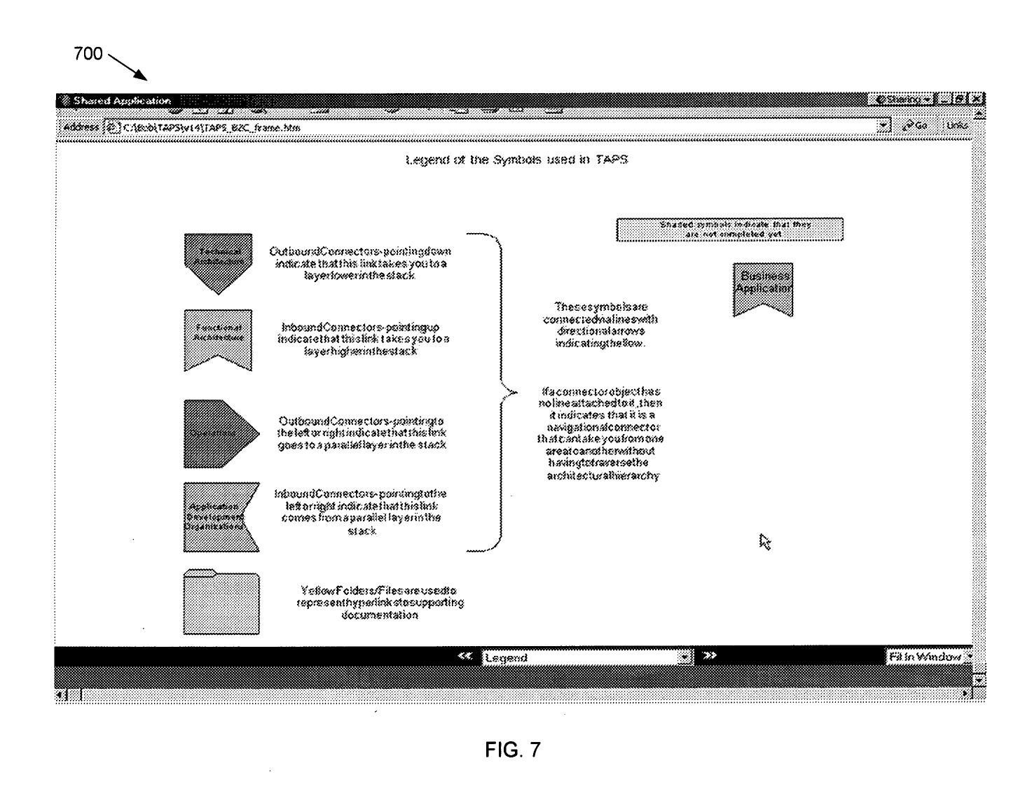

Finally, in FIG. 7, there is presented a display 700 of an exemplary legend created for the technical architecture plan. The legend may describe to a user the symbol shapes assigned to various components and the symbol colors assigned to the various groups involved in a project. The legend may be accessed, for example, by selecting the OffCon-Down symbol 302 having the caption “Legend” as shown in FIG. 3.

Using the TAPS framework can lower development costs because it's easier to combine information in order to build solutions. Project teams need not incur the additional expense of integration because the TAPS framework already describes how all the pieces of the technology stack work together. This will improve delivery time for development projects or improvements to existing architectures. Project teams will be able to deliver consistent technical solutions that leverage standardized reference architectures, thereby virtually eliminating re-design and integration challenges.

TAPS provides a login-specific aspect that allows users to be taken to a view within the architecture based on their login credentials. Likewise, a user may search through metadata associated with symbols and connectors to find information within an architecture plan. A user can specify an attribute of the architecture to search for and TAPS will retrieve (using a separate or integrated search engine which may be based on any of a variety of existing technologies) those pages based on the stored metadata, provided that the user is entitled to see them based on their login credentials. Such metadata may be stored in an Extensible Markup Language (XML) format, or other widely accepted data format, so that stored metadata may be easily transported between various application programs, and can be queried or operated on by a wide variety of search tools.

Although the best methodologies of the invention have been particularly described in the foregoing disclosure, it is to be understood that such descriptions have been provided for purposes of illustration only, and that other variations both in form and in detail can be made thereupon by those skilled in the art without departing from the spirit and scope of the present invention, which is defined first and foremost by the appended claims

What is claimed is:

1. A method for generating a technical architecture plan for display to a user on a computing device, comprising:
storing a plurality of pages, each visually representing a separate view of a development project;
receiving an assignment of a first symbol to a first component of the development project and an assignment of a second symbol to a second component of the development project;
receiving an assignment of a first color to a first group involved in the development project and an assignment of a second color to a second group involved in the development project, the first and second colors for application to at least one of the first and second symbols on at least one of the plurality of pages;
associating a user with at least one of the first and second groups; and
displaying those of the first and second symbols having the color assigned to the group with which the user is associated more prominently on each of the plurality of pages viewed by the user than those symbols having another assigned color.

2. The method of claim 1, said development project comprising an implementation of hardware and software components within an organization.

3. The method of claim 2, said first group comprising hardware technicians and said second group comprising software developers.

4. The method of claim 1, wherein each of the first and second symbols comprise a shape including a convex or concave arrowhead that is oriented to point to a direction within the pages of the development project having further information related to the component represented by the symbols.

5. The method of claim 1, wherein each of the first and second symbols have associated metadata for, and network pointers to, detailed information related to the components represented by the symbols.

6. The method of claim 1, wherein those of the first and second symbols having another color than that assigned to the group associated with the user are not displayed to the user.

7. The method of claim 1, wherein a lower level of the development plan has more detailed information of at least one of the components than a higher level of the development plan.

8. The method of claim 1, said associating further comprising:
associating the user with the group based on a login identifier entered by the user to view the development plan.

9. The method of claim 1, further comprising:
assigning a third color that is applied to symbols that are for display to both the first and second groups.

10. The method of claim 1, further comprising:
displaying at least one line connector symbol between at least two symbols on a page of the development plan.

11. The method of claim 1, further comprising:
displaying at least one file folder symbol on at least one of the plurality of pages, each file folder symbols having a network pointer to a portion of the development project identified in a caption of such file folder symbol.

12. The method of claim 1, further comprising:
providing at least one of an up connector symbol and a down connector symbol, for allowing the user to navigate to another level of the development project.

13. The method of claim 12, wherein the up connector symbol comprises a shape including a convex or concave arrowhead that is oriented to point to a top of the page of the development project being viewed, and allowing the user to navigate to a higher level of the development plan.

14. The method of claim 12, wherein the down connector symbol comprises a shape including a convex or concave arrowhead that is oriented to point to a bottom of the page of the development project being viewed, and allowing the user to navigate to a lower level of the development plan.

15. The method of claim 1, further comprising:
providing at least one of a left connector symbol and a right connector symbol for allowing the user to navigate to another portion of a level of the development project currently being viewed.

16. The method of claim 15, wherein the left connector symbol comprises a shape including a convex or concave arrowhead that is oriented to point to a left side of the page of the development project being viewed, and allowing the user to navigate to another view of that page of the development plan.

17. The method of claim 15, wherein the right connector symbol comprises a shape including a convex or concave arrowhead that is oriented to point to a right side of the page of the development project being viewed, and allowing the user to navigate to another view of that page of the development plan.

18. A method for creating a visual representation of a technical architecture plan, comprising:
providing a command for a user to create plurality of pages corresponding to separate levels of implementation of a development project;
providing a command for the user to assign a separate component symbol to each of a plurality of components of the development project, the component symbols for placement on at least one of the plurality of pages;
providing a command for the user to assign a separate color to each of a plurality of groups involved in the development project, the separate colors for application to at least one of the component symbols for which the corresponding group has responsibility; and
providing a command for the user to associate additional users with at least one of the plurality of groups, wherein those component symbols having a color assigned to a group of the additional users will be displayed more prominently than symbols having other colors; and
providing a command for the user to include a plurality of page connector symbols on at least one of the plurality of pages, each page connector symbol comprising one of an arrowhead that points in one of an up direction, a down direction, a left direction and a right direction, the page connector symbols allowing navigation to various views of the plurality of pages according to the direction of the arrowhead; and
generating a visual representation of the development plan in accordance with commands received from the user.

19. The method of claim 18, the separate component symbols including a convex arrowhead that may be oriented on a page to point to one of an up direction, a down direction, a right direction and a left direction, where further information related to the component may be found in the technical architecture plan.

20. An apparatus for generating a visual representation of a technical architecture plan, comprising:
a processor; and
a memory in communication with the processor, the memory for storing a plurality of processing instructions enabling the processor to:
receive commands from a user to establish a plurality of pages, each corresponding to one level of a development project;
receive, from the user, a placement of a plurality of separate component symbol on at least one of the plurality of pages, each separate component symbol representing one of a plurality of components of the development project, the separate component symbols including a convex arrowhead that may be oriented on a page to point to one of an up direction, a down direction, a right direction and a left direction where further information related to the component may be found in the technical architecture plan;
receive, from the user, an assignment of a separate color to each of a plurality of groups involved in the development project, the separate colors for application to at least one of the component symbols for which the corresponding group has responsibility; and
receive, from the user, an identification of additional users and an identification of the group to which the additional users belong, wherein those component symbols having a color assigned to a group of the additional users will be displayed more prominently than symbols having other colors;
receive, from the user, a plurality of page connector symbols on at least one of the plurality of pages, each page connector symbol comprising one of a concave and a convex arrowhead that points in one of an up direction, a down direction, a left direction and a right direction, the page connectors allowing navigation to various views of the plurality of pages according to the direction of the arrowhead; and
generate a visual representation of the development plan in accordance with the assignments and commands received from the user.
